(19) United States
(12) Patent Application Publication
(10) Pub. No.: US 2015/0067753 A1
(43) Pub. Date: Mar. 5, 2015

(54) GENERATING FRAME CHUNKING FOR VIDEO FAST STARTS

(71) Applicant: F5 Networks, Inc., Seattle, WA (US)

(72) Inventor: Yaniv Shemesh, Redmond, WA (US)

(73) Assignee: F5 Networks, Inc., Seattle, WA (US)

(21) Appl. No.: 14/470,388

(22) Filed: Aug. 27, 2014

Related U.S. Application Data
(60) Provisional application No. 61/871,716, filed on Aug. 29, 2013.

(51) Int. Cl. H04N 21/238; H04N 21/647

(52) U.S. Cl. CPC H04N 21/238; H04N 21/64738
USPC 725/116

(57) ABSTRACT

A network device is arranged to perform frame chunking directed towards enabling fast video content starts on a client device. When a request for video content is received, characteristics of a connection to the client device, and the client device are used to determine a threshold bitrate that provides a defined amount of video content to the client device within a configurable amount of first play time. When a bitrate for the video content that satisfies the threshold bitrate is currently unavailable, then the first chunks or bytes of the video content may be optimized to satisfy the threshold bitrate. The optimized first chunks are then provided to the client device followed by the remaining video content at an available bitrate.

### RELATED APPLICATIONS

This application is a Utility Patent application based on a previously filed U.S. Provisional Patent Application, U.S. Ser. No. 61/871,716 filed on Aug. 29, 2013, the benefit of the filing date of which is hereby claimed under 35 U.S.C. §119(e).

### TECHNICAL FIELD

The present invention relates generally to network communications, and more particularly, but not exclusively, to reducing video chunk sizes to provide video fast starts at a client device based in part on determined network bandwidth.

### TECHNICAL BACKGROUND

According to some studies, the volume of information over a network, such as the Internet, is expected to more than triple over the next three years. Data and content is likely to remain the largest percentage of Internet traffic, with the majority of this information being dynamic. A large amount of the content being sent over the network includes videos, often being sent to smaller sized, mobile devices. As a result, a major complaint among Internet users is the amount of time that it often takes from requesting a video or other multimedia content, and when the content begins to play on their computing device. Such initial end-user perceived performance may be a major factor for satisfaction and have a potential impact on business. Thus, it is with respect to these considerations and others that the present invention has been made.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

For a better understanding of the described embodiments, reference will be made to the following Detailed Description, which is to be read in association with the accompanying drawings, wherein:

FIG. 1 shows components of an illustrative environment in which the described embodiments may be practiced;

FIG. 2 shows one embodiment of a network device usable to perform frame chunking in accordance with at least one of the various embodiments;

FIG. 3 illustrates a logical flow of one embodiment of a process usable to provide faster first frame chunks in accordance with at least one of the various embodiments; and

FIG. 4 shows a logical sequence diagram for a process for generating frame chunking for fast starts in accordance with at least one of the various embodiments.

### DETAILED DESCRIPTION

In the following detailed description of exemplary embodiments, reference is made to the accompanied drawings, which form a part hereof, and which show by way of illustration examples by which the described embodiments may be practiced. Sufficient detail is provided to enable those skilled in the art to practice the described embodiments, and it is to be understood that other embodiments may be utilized, and other changes may be made, without departing from the spirit or scope. Furthermore, references to “one embodiment” are not required to pertain to the same or singular embodiment, though they may. The following detailed description is, therefore, not to be taken in a limiting sense, and the scope of the described embodiments is defined only by the appended claims.

Throughout the specification and claims, the following terms take the meanings explicitly associated herein, unless the context clearly dictates otherwise. As used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “network connection” refers to a collection of links and/or software elements that enable a computing device to communicate with another computing device over a network. One such network connection may be a Transmission Control Protocol (TCP) connection. TCP connections are virtual connections between two network nodes, and are typically established through a TCP handshake protocol. The TCP protocol is described in more detail in Request for Comments (RFC) 793, available from the Internet Engineering Task Force (IETF), and is hereby incorporated by reference in its entirety. A network connection “over” a particular path or link refers to a network connection that employs the specified path or link to establish and/or maintain a communication. The term “node” refers to a network element that typically interconnects one or more devices, or even networks.

As used herein, the term “content” includes any digital data that may be communicated over a network to be remotely played by a computing device. Non-exhaustive examples of content include but are not limited to movies, videos, music, spoken word, pictures, illustrations, graphics, images, text, and the like. Video or multimedia content refers to content having a video component.

Content is often described by its format, or container, in which the content is provided. Thus, as used here, the term “container” refers to a data stream or file format which encapsulates audio and visual content. This content often consists of interleaved audio and video data in frames, with accompanying metadata such as frame timing information, audio and/or video configuration information, encoding information, compression information, and the like. Also, the container is typically arranged to enable content to be presented for playback at a remotely located network device, such as a client device. A container may also be named a “systems stream”. A non-limiting and non-exhaustive list of examples of container/system streams formats are: MPEG2-TS (Moving Picture Experts Group (“MPEG”) transport stream (“TS”)), flash video (“FLV”), MOV (a QuickTime file format), MP4, 3GP, and ASF (Advanced Systems Form), WebM Project file format, Matroska multimedia container format, or the like. A video encoding format, such as H.264, VP8, or the like, may be encapsulated in the container. The content may be distributed as a rights managed systems stream of data over a network such as Pay per View (PPV), Video On Demand (VoD), live streaming, or the like for playback by a remote network device. In one embodiment, the content may be protected through a license that describes how, where, when, by whom, or so forth, content that is protected may be accessed, distributed, copied, or the like. Protected content may be protected using a variety of content protection mechanisms.

Other container/system stream formats include audio video interleave (AVI) format. The AVI is one example of a multimedia container format that includes both audio and video data in the file container to allow synchronous audio-with-video playback. In one embodiment, the AVI format divides a file's data into blocks, or “chunks.” Each chunk is identified by a fourCC tag. Typically, an AVI file takes the form of a single chunk, which is then subdivided into two mandatory chunks and one optional chunk. The first sub-chunk is identified by an “hdrl” tag, and includes the file header and metadata about the video, such as its width, height, frame rate, or the like. The second sub-chunk is identified by the “movi” tag, and includes the actual audio/video data that makes up the AVI video. The third optional sub-chunk is identified by the “idxl” tag which indexes the offsets of the data chunks within the file. References below to the first chunks are directed towards at least the first two sub-chunks, and optionally the third sub-chunk. Several other container/system formats include similar, albeit different, chunk structures. Moreover, some file formats, such as the M3U format stores multimedia playlists. M3U formats may be implemented as a plain text file that specifies locations of one or more media files. A Unicode version of the M3U format is known as the M3U8 format, which uses UTF-8 Unicode characters. Both the M3U and the M3U8 formats may be used for HTTP Live Streaming formats, often used by Apple, and others, to stream videos to various computing devices.

As used herein, the “first content chunk” refers to a portion of the content that is at the beginning of the content. In media content protocols that are chunked, a first content chunk is one or more of the first chunks of the content as described in the manifest information for the media content. In at least one of the various embodiments, first content chunks may be addressed/identified using URIs, URLs, or the like. Some media protocols, such as, progressive download protocols, may not arrange the media content into separate chunks provided to clients over separate requests. However, the TMD may be arranged to optimize the beginning portions of the progressive download similarly as it optimizes the first content chunks.

As used herein, the term “streaming digital content” refers to digital content constantly received by and prepared for presentation for play at a client device while being delivered by a provider, typically over a network such as the Internet. With streaming, the client device can start playing the digital content before the entire content stream has been transmitted/received at the client device. Source content for streaming digital content may be arranged into multiple chunks of media corresponding to a set duration or play time. For example, a 120 second long video may be arranged into 12 chunks of 10 seconds each. Accordingly, a media player may make multiple network requests to obtain the 12 chunks of video in order from start to finish to seamlessly/continuously present the entire 120 second video. Typically, the content provider may pre-generate the chunks from the original content in advance. Also, some streaming digital content protocols may support multiple streams of content that are arranged to have content delivery characteristics targeted for the capabilities of various client computers, media players, network bandwidth, or the like, or combination thereof.

As used herein, the “delivery characteristic” refers to properties related to the delivery of content to a client computer. These properties may include bit-rate, display resolution, total length (duration), number of chunks, chunk duration, locations for each chunk (URIs), digital rights management (DRM) information, cryptographic information, compute capacity/requirement, buffering size, buffer size, or the like, or combination thereof. Client delivery characteristics refer to delivery characteristics that are associated with a client computer that may be requesting content. Content delivery characteristics refer to delivery characteristics that may be associated with requested content or a portion of the requested content.

As used herein, the terms “manifest,” or “manifest file” refer to a documents/files that include meta-data for describing one or more of the delivery characteristics of the content that may be made available by a content server. Various media players and/or media protocols support one or more well-known formats for manifest files. Manifest files for streaming media often include information that describes the properties the different streams that may be available for a media presentation. These properties may include information such as optimal bit-rate, display resolution, total length (duration), number of chunks, chunk duration, locations for each chunk (URIs), digital rights management (DRM) information, cryptographic information, or the like, or combination thereof.

The following briefly provides a simplified summary of the subject innovations in order to provide a basic understanding of some aspects. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, subject innovations are directed toward performing frame chunking on first chunks of a video stream for fast video starts at a client device. In one embodiment, a network device may be interposed between a requesting client device, and one or more server devices having video content. The intermediate network device may also obtain various characteristics about the network connect over which the request is received, as well as information about the requesting client device. A manifest file may be obtained that provides information about available bitrates for the requested video content. When it is determined that a low enough bitrate is available that is expected to transfer to the client device within some definable rate, then that version of the video content is provided to the client device, skipping optimization of at least the first chunks of video content. When no version of the video content is available at a sufficiently low bitrate, then, alternative first chunks to be served to the client device may be prepared. These alternative first chunks may be ‘optimized’ to satisfy a definable criterion, such as able to transfer within a defined time for the requesting client device/network connection. Other criteria may also be used. These optimized first chunks are expected to have a smaller payload size and therefore download faster to the requesting client device. A total length of the optimized chunks, in some embodiments, might account for a first few playback seconds, and include the first one or two chunk files. By directing optimization towards the first chunks, transcoding/translating and other optimization actions that might be more resource intensive can be avoided. The optimized chunks may include content that employs higher compression codecs (“coder-decoder” or, less commonly, “compressor-decompressor”), and/or lower quality of frames/smoothness, in some embodiments. Moreover, in some embodiments, a size of each of the first optimized chunks could be optionally varied based on a determined client device buffer size, network bandwidth, or the like to enable client devices a faster upgrade back to an original higher quality video content stream. In progressive downloads, where a file which contains the video/audio content is downloaded as a single HTTP response, the optimization might alter/replace the first bytes of the file response with optimized data, as functionally equivalent to replacing the first chunks.

The innovations disclosed herein recognize that playing of a video stream by a client device may include a buffering time that might severely impact an initial end-user experience. This buffering delay may be compounded by a slower network speed, and/or other characteristics of the network, and/or client device, such as whether the client device is a smaller device. Moreover, methods of transcoding and optimizing an entire video stream may be resource expensive. However, in some embodiments, a beginning of a video content stream may include portions of content that may be perceived by an end-user as less interesting, such as pre-roll, logos, or the like. Therefore, the disclosed innovations have further considered these issues in its approach.

In at least one of the various embodiments, when a client computer requests content, one or more threshold values may be determined for one or more client delivery characteristics to provide the requested content to the requesting client computer such that the threshold values may be based on one or more characteristic of the network.

In at least one of the various embodiments, one or more content delivery characteristic may be determined based on media information (e.g., manifest files) that may be provided by a content server that offering the content. Further, in at least one of the various embodiments, the TMD may compare the one or more content delivery characteristics to the threshold values. Accordingly, in at least one of the various embodiments, if the comparison indicates that one or more threshold values may be exceeded by one or more content delivery characteristic, additional actions may be performed.

In at least one of the various embodiments, modifying an initial portion of the requested content to limit its content delivery characteristics to be less than the one or more threshold values. Communicating the modified initial portion to the client computer such that the modified portion may be substituted for an unmodified initial portion of the requested content. And, in at least one of the various embodiments, after the modified initial portion is communicated to the client computer, further communicating, a remaining portion of unmodified requested content to the client computer.

In at least one of the various embodiments, determining the one or more threshold values may further include determining the threshold values based on one or more characteristics of a request for the requested content. In at least one of the various embodiments, the determined threshold values may include a screen resolution, a bitrate, a buffer-size, a compute capacity, or a size of a display for presenting the requested content, or the like, or combination thereof.

In at least one of the various embodiments, a manifest provided by the content server may be examined by the TMD to determine one or more content delivery characteristics of the initial portion of the requested content.

In at least one of the various embodiments, modifying the initial portion of the requested content, may further include: determining alternate content that may be substantially equivalent to the requested content except that the one or more content delivery characteristics of the alternate content is less than the one or more threshold values; and, in at least one of the various embodiments, an initial portion of the alternate content may be selected and substituted for the initial portion of the requested content.

### Illustrative Operating Environment

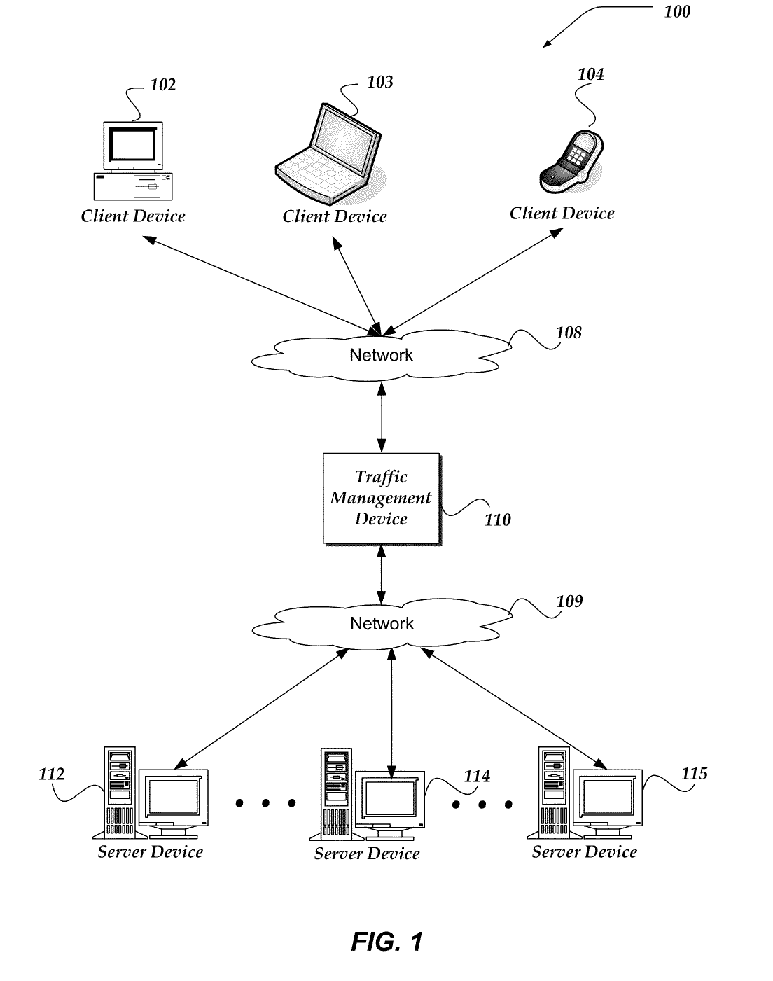

FIG. 1 shows components of an illustrative environment 100 in which the described embodiments may be practiced. Not all the components may be required to practice the described embodiments, and variations in the arrangement and type of the components may be made without departing from the spirit or scope of the described embodiments. FIG. 1 illustrates client devices 102-104, networks 108-109, and Traffic Management Device (TMD) 110.

Generally, client devices 102-104 may include virtually any computing device capable of connecting to another computing device and receiving information. Such devices may include personal computers, multiprocessor systems, microprocessor-based or programmable consumer electronics, network devices, server devices, and the like. Client devices 102-104 may also include portable devices such as, cellular telephones, smart phones, display pagers, radio frequency (RF) devices, infrared (IR) devices, Personal Digital Assistants (PDAs), handheld computers, wearable computers, tablet computers, integrated devices combining one or more of the preceding devices, and the like. Client devices 102-104 may also include virtual computing devices running in a hypervisor or some other virtualization environment. As such, client devices 102-104 may range widely in terms of capabilities and features.

A web-enabled client device may include a web browser application that is configured to receive and to send web pages, web-based messages, and the like. The web browser application may be configured to receive and display graphics, text, multimedia, and the like, employing virtually any web based language, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SMGL), HTML, eXtensible Markup Language (XML), Compact HTML (cHTML), EXtensible HTML (xHTML), or the like, to display and send a message. In some embodiments, video content may be streamed to the client device using HTTP; however, other mechanisms may also be used.

Client devices 102-104 also may include at least one other client application that is configured to receive content from another computing device. The client application may include a capability to provide and receive textual content, graphical content, audio content, and the like. The client application may further provide information that identifies itself, including a type, capability, name, and the like. In one embodiment, client devices 102-104 may uniquely identify themselves through any of a variety of mechanisms, including a phone number, Client Identification Number (MIN), an electronic serial number (ESN), or other client device identifier. The information may also indicate a content format, and/or a capability of the client device. For example, in one embodiment, the client application may be configured to provide information about a type of client device, an application available on the client device, available buffer sizes for buffering received content, or the like.

As further shown in FIG. 1, networks 108-109 are configured to couple network enabled devices, such as client devices 102-104, TMD 110, and server devices 112-115, with other network enabled devices. Networks 108-109 are enabled to employ any form of computer readable media for communicating information from one electronic device to another. In one embodiment, network 108 may include the Internet, and may include local area networks (LANs), wide area networks (WANs), direct connections, such as through a universal serial bus (USB) port, other forms of computer-readable media, or any combination thereof. On an interconnected set of LANs, including those based on differing architectures and protocols, a router may act as a link between LANs to enable messages to be sent from one to another. Also, communication links within LANs typically include fiber optics, twisted wire pair, or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art.

Networks 108-109 may further employ a plurality of wireless access technologies including, but not limited to, 2nd (2G), 3rd (3G), 4th (4G) generation radio access for cellular systems, Wireless-LAN, Wireless Router (WR) mesh, and the like. Access technologies such as 2G, 3G, 4G, and future access networks may enable wide area coverage for network devices, such as client devices 102-104, or the like, with various degrees of mobility. For example, networks 108-109 may enable a radio connection through a radio network access such as Global System for Mobil communication (GSM), General Packet Radio Services (GPRS), Enhanced Data GSM Environment (EDGE), Wideband Code Division Multiple Access (WCDMA), and the like.

Furthermore, remote computers and other related electronic devices could be remotely connected to either LANs or WANs via a modem and temporary telephone link, a DSL modem, a cable modem, a fiber optic modem, an 802.11 (Wi-Fi) receiver, and the like. In essence, networks 108-109 include any communication method by which information may travel between one network device and another network device.

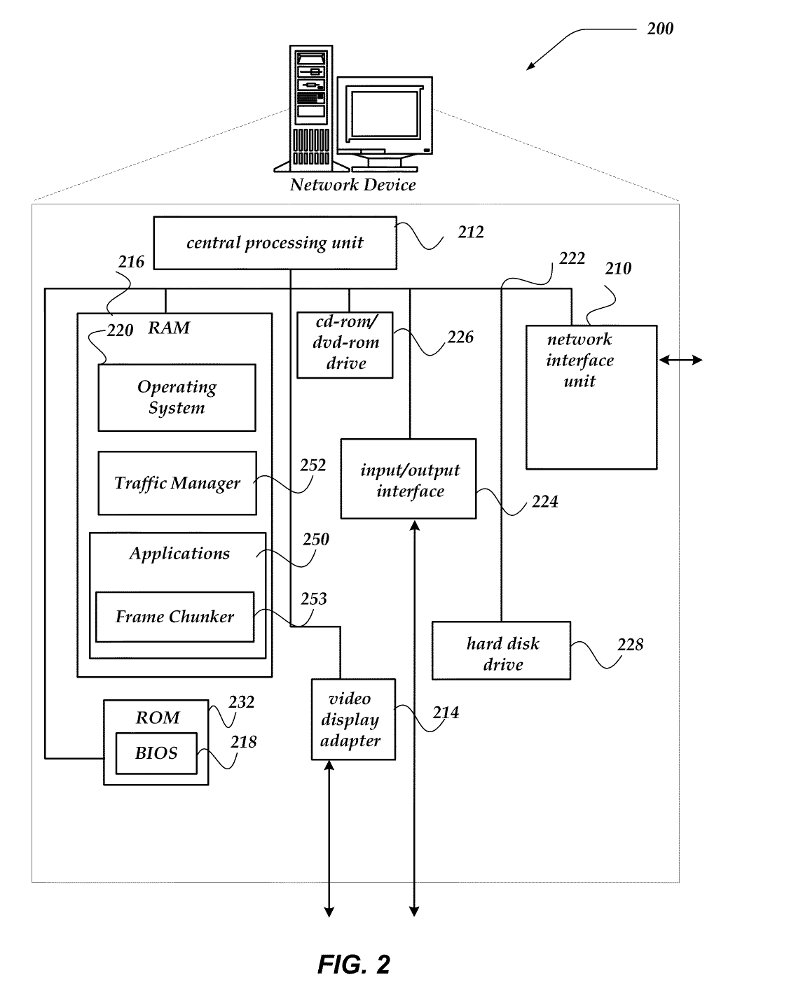

One embodiment of a Traffic Management Device 110 is described in more detail below in conjunction with FIG. 2. Briefly, however, TMD 110 includes virtually any network device that manages network traffic. Such devices include, for example, routers, proxies, firewalls, load balancers, cache devices, application accelerators, devices that perform network address translation, any combination of the preceding devices, or the like. TMD 110 may control, for example, the flow of data packets delivered to or forwarded from an array of server devices, such as server devices 112-115.

TMD 110 may direct a request for a resource to a particular server device based on network traffic, network topology, capacity of a server device, content requested, and a host of other traffic distribution mechanisms. TMD 110 may receive data packets from and transmit data packets to the Internet, an intranet, or a local area network accessible through another network. TMD 110 may recognize packets that are part of the same communication, flow, and/or stream and may perform special processing on such packets, such as directing them to the same server device so that state information is maintained. TMD 110 also may support a wide variety of network applications such as Web browsing, email, telephony, streaming multimedia and other traffic that is sent in packets. The BIG-IP® family of traffic managers, by F5 Networks of Seattle, Wash., are examples of TMDs.

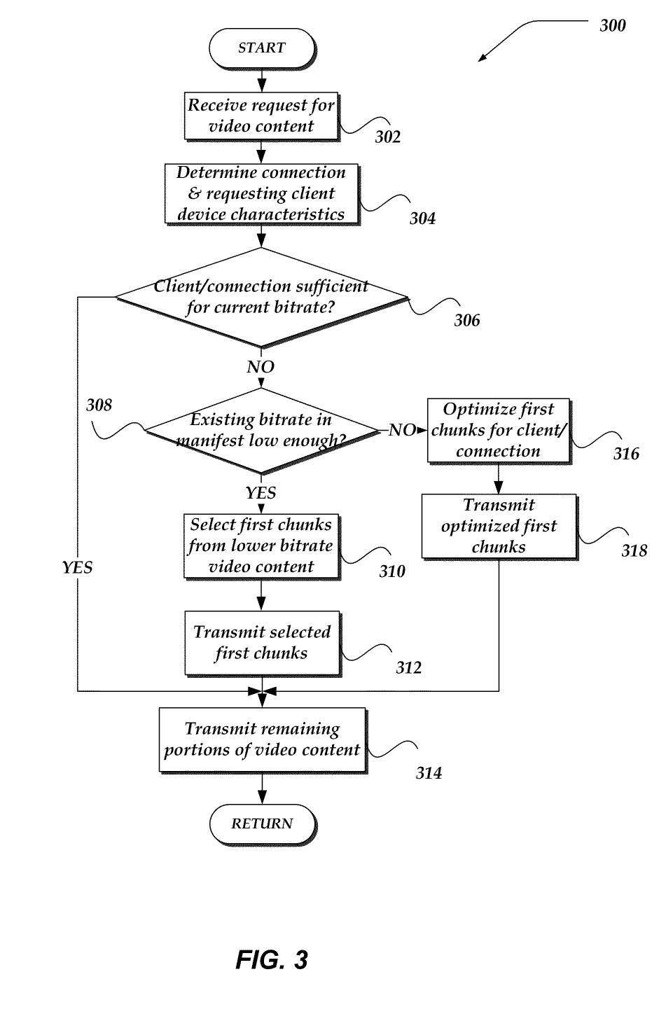

In one embodiment, TMD 110 may employ a process described further below in conjunction with FIG. 3 to perform fast video starts for a client device by optimizing first chunks of a requested video stream. In one embodiment, optimization may include employing a higher compression codec, and/or lowered quality of frames/smoothness, or the like. In one embodiment, a determination of whether or not to perform optimization on the first chunks may be based on one or more characteristics of the requesting client device and/or a network characteristic over which the request is received. If optimization is performed for video content associated with a manifest file that includes information about available bitrates for the video content, no change to the manifest file is performed, or to the requested URI. In this manner, switching the client device over to the available bitrate streams is simplified, and avoids possibly transcoding/transrating the entire video content stream rather than merely the first chunks.

Server devices 112-115 may include any computing device capable of communicating packets to another network device. Each packet may convey a piece of information. A packet may be sent for handshaking, i.e., to establish a connection or to acknowledge receipt of data. The packet may include information such as a request, a response, or the like. Generally, packets received by server devices 112-115 will be formatted according to TCP/IP, but they could also be formatted using another transport protocol, such as SCTP, X.25, NetBEUI, IPX/SPX, token ring, similar IPv4/6 protocols, and the like. Moreover, the packets may be communicated between server devices 112-115, TMD 105, and client device 102 employing HTTP, HTTPS, or any of a variety of protocols.

In one embodiment, server devices 112-115 are configured to operate as a website server. However, server devices 112-115 are not limited to web server devices, and may also operate a messaging server, a File Transfer Protocol (FTP) server, a database server, content server, and the like. Additionally, each of server devices 112-115 may be configured to perform a different operation. Thus, for example, server device 112 may be configured as a messaging server, while server device 113 is configured as a database server. Moreover, while server devices 112-115 may operate as other than a website, they may still be enabled to receive an HTTP communication, as well as a variety of other communication protocols.

In some embodiments, server devices 112-115 may store video content that may be provided to TMD 110 in response to a request. Moreover, server devices 112-115 may also store a manifest file associated with one or more video content streams, where the manifest file includes information about available bitrates available for a video content. For example, the manifest file might indicate that for a given video content, the given video content is available at several different bitrates. A request from TMD 110 might then select the video content at one of the available bitrates for providing to the requesting client device.

Devices that may operate as server devices 112-115 include personal computers, desktop computers, multiprocessor systems, microprocessor-based or programmable consumer electronics, network PCs, server devices, and the like.

### Illustrative Network Device

FIG. 2 shows one embodiment of a network device, according to one embodiment of the invention. Network device 200 may include many more or less components than those shown. The components shown, however, are sufficient to disclose an illustrative embodiment for practicing the invention. Network device 200 may represent, for example, TMD 110 of FIG. 1.

Network device 200 includes processing unit 212, video display adapter 214, and a mass memory, all in communication with each other via bus 222. The mass memory generally includes RAM 216, ROM 232, and one or more permanent mass storage devices, such as hard disk drive 228, tape drive, optical drive, and/or floppy disk drive. The mass memory stores operating system 220 for controlling the operation of network device 200. Network device 200 also includes applications 250, and traffic manager 252. Applications 250 further include Frame Chunker 253.

As illustrated in FIG. 2, network device 200 also can communicate with the Internet, or some other communications network via network interface unit 210, which is constructed for use with various communication protocols including the TCP/IP protocol. Network interface unit 210 is sometimes known as a transceiver, transceiving device, or network interface controller (NIC) card.

The mass memory as described herein illustrates another type of computer readable media, namely computer storage devices. Computer storage devices may include volatile, nonvolatile, removable, and non-removable devices implemented in any method or technology for non-transitory storage of information, such as computer readable instructions, data structures, program modules, or other data. Examples of computer storage devices include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other physical non-transitory medium which can be used to store the desired information and which can be accessed by a computing device.

The mass memory also stores program code and data. One or more applications 250 are loaded into mass memory and run on operating system 220. Examples of application programs may include email programs, routing programs, schedulers, calendars, database programs, word processing programs, HTTP programs, traffic management programs, security programs, and so forth. Applications 250 also include Frame Chunker 253.

Network device 200 may also include an SMTP handler application for transmitting and receiving e-mail, an HTTP handler application for receiving and handing HTTP requests, and an HTTPS handler application for handling secure connections. The HTTPS handler application may initiate communication with an external application in a secure fashion. Moreover, network device 200 may further include applications that support virtually any secure connection, including TLS, TTLS, EAP, SSL, IPSec, and the like.

Network device 200 may also include traffic manager 252 that is configured to control the flow of data packets delivered to and forwarded from various devices. Traffic manager 252 may direct a request for a resource to a particular device based on network traffic, network topology, capacity of a device, content requested, and a host of other traffic distribution mechanisms. Traffic manager 252 may receive data packets from and transmit data packets to the Internet, an intranet, or a local area network accessible through another network. Traffic manager 252 may recognize packets that are part of the same communication, flow, and/or stream and may perform special processing on such packets, such as directing them to the same server so that state information is maintained.

Network device 200 may also include input/output interface 224 for communicating with external devices, such as a mouse, keyboard, scanner, or other input devices not shown in FIG. 2. Likewise, network device 200 may further include additional mass storage facilities such as CD-ROM/DVD-ROM drive 226 and hard disk drive 228. Hard disk drive 228 may be utilized to store, among other things, application programs, databases, and the like.

In one embodiment, the network device 200 includes at least one Application Specific Integrated Circuit (ASIC) chip (not shown) coupled to bus 222. The ASIC chip can include logic that performs some of the actions of network device 200. For example, in one embodiment, the ASIC chip can perform a number of packet processing functions for incoming and/or outgoing packets. In one embodiment, the ASIC chip can perform at least a portion of the logic to enable the operations of Frame Chunker 253. Frame Chunker 253 is configured to perform actions that include those discussed below in conjunction with FIG. 3 that includes providing frame chunking when it is determined that characteristics of a network connection and/or the client device indicate that frame chunking might enable fast video starts on the client device.

In one embodiment, network device 200 can further include one or more field-programmable gate arrays (FPGA) (not shown), instead of, or in addition to, the ASIC chip. A number of functions of the network device can be performed by the ASIC chip, the FPGA, by CPU 212 with instructions stored in memory, or by any combination of the ASIC chip, FPGA, and CPU.

### Generalized Operation

The operation of certain aspects will now be described with respect to FIG. 3. FIG. 3 illustrates a logical flow of one embodiment of a process usable to perform frame chunking for video fast starts. In one embodiment, process 300 of FIG. 3 may be implemented with TMD 110 of FIG. 1. However, in other embodiments, process 300 may be implemented within another network device, such as server devices 112-114. In some embodiments, process 300 may be stored within a physical non-transitory device as computer-executable instructions that when installed within a network device, such as TMD 110, performs the actions disclosed below.

In at least one of the various embodiments, process 300 begins, after a start block, at block 302, where a request for video content is received. In one embodiment, the request may include a reference to a video content location, such as through a uniform resource locator (URL), uniform resource identifier (URI), or similar location identifier. In one embodiment, the URL may be to video content having a predefined bitrate. Moving to block 304, a determination is made regarding network connection characteristics for the network over which the request is received. In some embodiments, the determination might include obtaining an estimated bandwidth, determining whether the network includes jitter, or other features. In some embodiments, such information might be determined from a previous communication with the requesting client device, such as during network packet transfers when the client device is requesting a webpage containing the video content, or the like. Additionally, information from the Transmission Control Protocol (TCP) connection, including, but not limited to a Round Trip Time (RTT), bandwidth, previously collected TCP metrics, or the like, might be obtained, and used. Further, various characteristics of the requesting client device may also be determined based on a variety of mechanisms, including, but not limited to receiving from the client device a user-agent request header, or the like. Such information may also include whether the client device is a mobile device, and therefore likely to include smaller buffers for streamed content, or the like.

In some embodiments, a buffer size on the client device might be determined from the user-agent information corresponding to the request for the content. Using these characteristics, a desired or threshold bitrate for the requested video content may be determined. In one embodiment, the threshold bitrate may be based on such criteria as what bitrate would be needed to provide a defined amount of video content over this particular network connection for this particular client device within a defined or otherwise configurable amount of time. Other criteria for threshold bitrate may also be defined. Moreover, in some embodiments, the threshold bitrate might be defined for a class/type/category of related network connections/client devices.

Processing then flows to decision block 306, where a determination is made whether the client device and/or a media player running on the client device have characteristics and network connections that may be sufficient for the requested video content's bitrate. The available bitrate for the requested video content may be obtained, in some embodiments, by parsing a manifest file that indicates at which bitrate the video content is available. By employing the requested URL (or similar identifier from the request), the manifest file may be examined to determine what the associated bitrate is for the requested video content. In other embodiments, the bitrate for the requested video content for the requested URL may be determined by examining the video content directly. Other mechanisms may also be employed. In any event, if it is determined that the client device's characteristics/network connections are sufficient for the video content associated with the requested URL, then processing flows to block 314. In one embodiment, this evaluation may be based on a comparison of the threshold bitrate to the bitrate for the video content associated with the requested URL. That is, if the video content is determined to have a bitrate below the determined threshold bitrate, then processing flows to block 314; otherwise, processing flows to decision block 308.

At decision block 308, a determination is made based on reviewing the manifest file, or similar mechanism, whether the requested video content is available at a lower bitrate that satisfies the threshold bitrate. In some embodiments, the manifest file might indicate that the video content is available in a plurality of different bitrates, where each of the different bitrate video contents might be obtained from a different location (URL, or the like). If the video content is available at a different bitrate that satisfies the threshold bitrate, then processing continues to block 310; otherwise, processing flows to block 316.

At block 316, the video content for the available bitrate that satisfies the threshold bitrate is obtained. In one embodiment, the first chunks from the video content stream that satisfies the threshold bitrate are selected or otherwise obtained. Processing then flows to block 312, where these first chunks replace or are otherwise transmitted to the requesting client device instead of the first chunks from the requested video content at the requested URL. In one embodiment, these first chunks may be cached or otherwise temporarily saved in a manner that expedites retrieval of the first chunks for a subsequent request from the same or similar client device/network connection configuration. Processing then flows to block 314.

At block 316, at least the first chunks of the video content are optimized to satisfy the threshold bitrate. Any of a variety of mechanisms may be used to optimize the video content. For example, in some embodiments, a higher lossless compression codec might be applied to the video content for the first chunks. In other embodiments, a higher lossy frame compression and/or other transrating mechanisms may be applied to lower the frame per second bitrate for the first chunks. In still other approaches transizing of the first chunks of video content might be performed. Use of information about the client device, such as buffer size, and/or its network connection may also be employed to optimize the first chunks. For example, a compression codec could be selected to attempt to manage a size of the first chunks so as to be able to fit within the determined buffer size.

Moreover, in some embodiments, setting the number of chunks that will define the ‘optimized chunks’ can be done based on a desired “head start” playback time/duration and need not be limited by an actual number of original chunks, as specified in the manifest file. Thus, for example, when the first ten seconds of a high-definition video stream is comprised of any small playback duration chunks, each having many bytes (in size), then the stream may be transformed to a same corresponding amount of chunks but with each being a smaller sized payload. Additionally, as media players usually fully download both the first chunk and buffer the next consecutive chunk before starting to play, the number of these first optimized chunks can be set to include at least two chunks. However, the first chunks are not constrained to two, and other numbers of chunks may represent the first chunks. For example, in one embodiment the first chunks might include any number of beginning chunks for the video content that is less than all of the video content. Additional considerations for setting the optimized chunks duration might further include a most commonly accessed client's bandwidth, the current bandwidth (as noted above), a bandwidth jitter, and/or a total byte size of the video file. For example, the longer the video file is determined to be, the more chances that a weak client will encounter playback buffering later after upgrading back to an original higher bitrate, thereby exhausting the “head start” buffer. Other mechanisms may also be employed.

It is noted, that no changes are performed on the manifest file or URLs/URIs associated with the video content. This is directed towards enabling transitions between chunks to occur more transparently. Changing of the manifest file by adding, for example, an additional lower bitrate stream may limit control of switching the client device over to the available bitrate and may further require transcoding/transrating of the entire video content, instead of the first few chunks. This would be more resource intensive. In any event, upon completion of the optimization of the determined first chunks, processing flows to block 318, where the optimized first chunks are transmitted to the client device rather than the first chunks within the video content at the requested URL.

In the instances of progressive downloads of video content, which may be transferred as a single HTTP response, then the first bytes of the payload might be replaced with the optimized chunks when the content is transmitted to the client device. Processing then continues to block 314.

At block 314, the video content from the requested URL may then be provided to the client device. Where the block 314 is performed from decision block 306, the first chunks are also provided to the client device. However, where the flow is from block 312 or 318, because the first chunks are already transmitted, the remaining portions of the requested video content are provided to the client device. Processing then returns to a calling process.

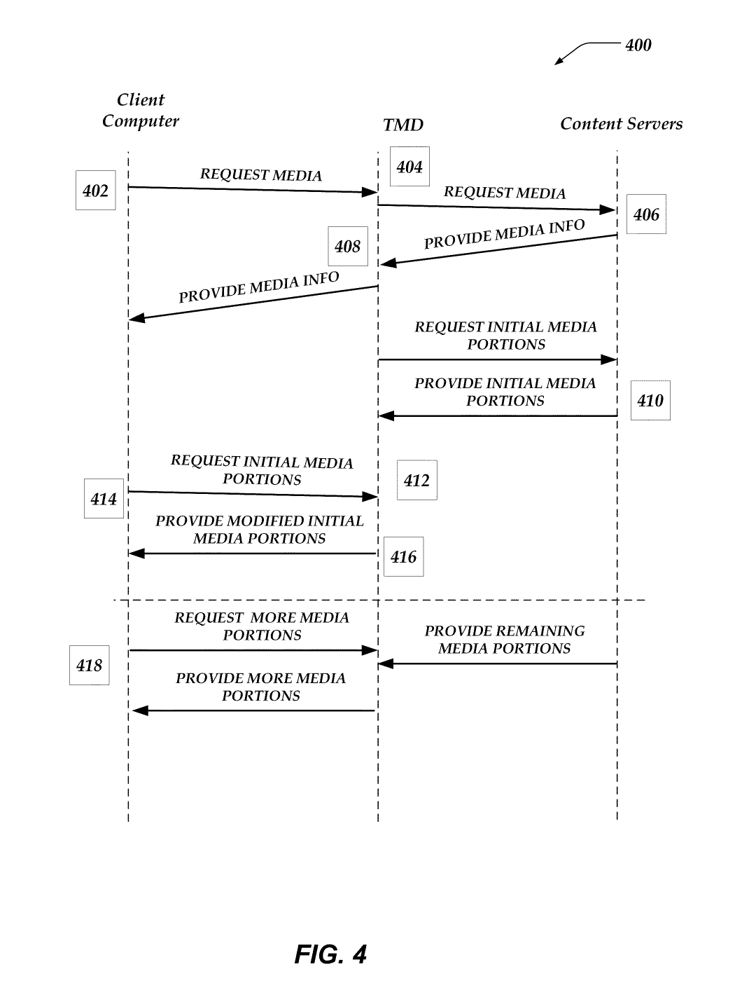

FIG. 4 shows a logical sequence diagram for process 400 for generating frame chunking for fast starts in accordance with at least one of the various embodiments. In at least one of the various embodiments, at step 402, a request from a client computer may generated for a particular content. In at least one of the various embodiments, the request may be formed using a stand-alone media player executing on the client computer. Or, in at least one of the various embodiments, the request may be provided by a browser application. For example, a user may click on a link (URL) to a music video on a web page. In at least one of the various embodiments, the request may be a HTTP request that includes information for identifying and locating the desired content. At step 404, in at least one of the various embodiments, a TMD, or other intermediate device that may be separate from the content servers may receive and/or intercept the request for the content. One or more well-known network configuration, traffic management techniques may be employed for enabling the TMD to receive and/or intercept the request for media content. In at least one of the various embodiments, the TMD may perform one or more well-known traffic management actions, such as, load balancing, cache management, DRM, or the like, or combination thereof, for determining one or more content servers which to communicate the request.

At step 406, in at least one of the various embodiments, the content servers may respond to the request by providing the requested content, a portion of the request content, or information about the requested content (e.g., media information, or manifest information) back to the TMD.

At step 408, in at least one of the various embodiments, the TMD may examine the media information and/or forward it to the requesting client computer. In at least one of the various embodiments, step 402 through step 408 may include one or more handshaking steps/transactions (not shown) that may include exchanging manifest information such as information describing one or more alternative media streams and/or alternate content that may be available of on the content server. Further, in at least one of the various embodiments, information for about the content, such as, content portion lists, content portion locations, content portion sequences, content chunk lists, content chunk locations, content chunk sequences, or the like, may be exchanged during the handshaking

At step 410, in at least one of the various embodiments, as discussed in above in FIG. 3, the TMD may determine based on examining the media information and/or one or more of the delivery characteristics of the client computer that the media/content may be modified to improve the startup/launch time of the content on the client computer. In at least one of the various embodiments, the exchanged media information may be included in one or more manifest files provided by the content servers. These manifest files may correspond to the requested content. Also, in at least one of the various embodiments, since the TMD may be disposed between the requesting client computer and the content servers, the TMD may examine the manifest files and/or the media information for determining if optimization actions may be performed.

In at least one of the various embodiments, the TMD may determine one or more threshold values associated with one or more delivery characteristics of the content requested by the client computer. These threshold values may be determined based on characteristics of the network connection, the client computer, the request, or the like.

Further, in at least one of the various embodiments, when a client computer requests content, determining at least one threshold value for at least one client delivery characteristic to provide the content to the client computer, wherein the at least one threshold value may be based on at least one determined network characteristic of the network. At step 412, in at least one of the various embodiments, the TMD may fetch one or more of the initial portions of the content and begin processing them to optimize them for the requesting client. In at least one of the various embodiments, the TMD may also obtain sufficiently optimized content portions from a cache. In at least one of the various embodiments, the number of portions or chunks and/or the particular optimizations may be determined based on one or more policy based rules and/or configuration information. In at least one of the various embodiments, the content portions may be content chunks for the content.

In at least one of the various embodiments, at least one content delivery characteristic maybe determined based on the media information provided by a content server that provides access to the content. Also, in at least one of the various embodiments, the at least one content delivery characteristic may be compared to the at least one threshold value. Accordingly, in at least one of the various embodiments, when the comparison indicates that the at least one threshold value may be exceeded by the at least one content delivery characteristic one or more initial portions or content chunks of the requested content may be modified. In at least one of the various embodiments, one or more initial content portions for the requested content may be modified by the TMD to limit their content delivery characteristics to be less than one or more threshold values. This may ensure that is delivery characteristics to do not exceed the determined performance thresholds of the network connection or the client computer.

In at least one of the various embodiments, the content servers may offer alternate media content. In at least one of the various embodiments, the media information (e.g., manifest) may describe multiple alternate content selections (e.g., different media streams), each having different content delivery characteristics. Accordingly, in at least one of the various embodiments, the TMD may determine that one or more of the alternate content/media streams may include initial content portions (e.g., chunks) that have content delivery characteristics that do not exceed the threshold values determined for the client computer. For example, if the media information identifies an alternate media stream that has a bitrate that below the bitrate threshold of the client computer, the TMD may substitute the alternate content's initial portion for the initial portion of the requested content.

At step 414, in at least one of the various embodiments, based on the information provided in in step 408, the client computer (via its media player or web browser) may request one or more initial portions of the content. In at least one of the various embodiments, the media information may include manifest file information that may include a playlist of separate URI's for the content chunks and/or content portions that make up each available stream of the requested content. Based on examining the contents of the media information the media player and/or browser may determine a first content chunk and/or an initial content portion to request. For example, in at least one of the various embodiments, some streaming media protocols may provide separate URLs for each media content chunk. In these cases, the media player may be arranged to request each chunk separately and in order using the provided URLs.

At step 416, in at least one of the various embodiments, the TMD may provide one or more optimized/modified first chunks or modified initial portions of content in response to the client computer's request for the content. In at least one of the various embodiments, the TMD may be arranged to seamlessly and transparently substitute the optimized first content chunks and/or modified initial content portions for the original first content chunks and/or content portions that may have been provided by the content servers.

In at least one of the various embodiments, if the content servers offer alternate content or media streams that have content delivery characteristics that do not exceed the determined client delivery characteristic thresholds, the TMD may substitute first content chunks or initial content portions from the alternate content rather than modifying first content chunks or initial content portions from the requested content. For example, in at least one of the various embodiments, the client computer may communicate a request that includes a URL to a first content chunk of the requested media content. Accordingly, in this example, the TMD may intercept the client computer's request and transparently make a request for a first content chunk from the alternate media content stream. The first content chunks obtained from the alternate media stream may then be communicated to the client computer in lieu of the first content chunks from the requested (original) media content stream.

At step 418, in at least one of the various embodiments, after the modified first content chunks or the modified initial content portions have been communicated to and/or presented by the media player, a remaining portion of unmodified requested content may be provided to the client computer, Accordingly, the client computer may continue to request media content chunks based on the media information (e.g., the manifest file). However, from here on out, the TMD may provide the media content chunks to the client computer in their original unmodified form as provided by the content servers and/or content caches.

In at least one of the various embodiments, as per the underlying media protocol, the media player may continue to request content chunks or portions of the content until the entire requested content has been provided to the client computer.

It will be understood that figures, and combinations of steps in the flowchart-like illustrations, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions execute on the processor to provide steps for implementing the actions specified in the flowchart block or blocks. These program instructions may be stored on a computer readable medium or machine readable medium, such as a computer readable storage medium.

Accordingly, the illustrations support combinations of means for performing the specified actions, combinations of steps for performing the specified actions and program instruction means for performing the specified actions. It will also be understood that each block of the flowchart illustration, and combinations of blocks in the flowchart illustration, can be implemented by modules such as special purpose hardware-based systems which perform the specified actions or steps, or combinations of special purpose hardware and computer instructions.

The above specification, examples, and data provide a complete description of the manufacture and use of the composition of the described embodiments. Since many embodiments can be made without departing from the spirit and scope of this description, the embodiments reside in the claims hereinafter appended.

What is claimed as new and desired to be protected by Letters Patent of the United States is:

1. A method for managing communication of content over a network with a traffic management device (TMD) that performs actions, comprising:
when a client computer requests content, determining at least one threshold value for at least one client delivery characteristic to provide the content to the client computer, wherein the at least one threshold value is based on at least one determined network characteristic of the network;
determining at least one content delivery characteristic based on media information provided by a content server that provides access to the content;
comparing the at least one content delivery characteristic to the at least one threshold value; and
when the comparison indicates that the at least one threshold value is exceeded by the at least one content delivery characteristic, performing further actions, comprising:
modifying at least an initial portion of the requested content to limit its content delivery characteristic to be less than the at least one threshold value;
communicating the modified initial portion to the client computer, wherein the modified portion is substituted for an unmodified initial portion of the requested content; and
after the modified initial portion is communicated to the client computer, further communicating, a remaining portion of unmodified requested content to the client computer.

2. The method of claim 1, wherein determining the at least one threshold value, further comprises, determining the at least one threshold value based on at least one characteristic of a request for the requested content.

3. The method of claim 1, wherein the at least one determined threshold value, further comprises at least one of a screen resolution, a bitrate, a buffer-size, a compute capacity, or a size of a display for presenting the requested content.

4. The method of claim 1, further comprising, examining a manifest to determine at least one content delivery characteristic of the initial portion of the requested content.

5. The method claim 1, wherein modifying the initial portion of the requested content, further comprises,
determining an alternate content that is substantially equivalent to the requested content except that the at least one content delivery characteristic of the alternate content is less than the at least one threshold value; and
selecting an initial portion of the alternate content, wherein the alternate content's initial portion is substituted for the initial portion of the requested content.

6. A network computer for managing communication of content over a network, comprising:
a transceiver for communicating over the network;
a memory for storing at least instructions;
a processor device that executes instructions that enable operations, including:
when a client computer requests content, determining at least one threshold value for at least one client delivery characteristic to provide the content to the client computer, wherein the at least one threshold value is based on at least one determined network characteristic of the network;
determining at least one content delivery characteristic based on media information provided by a content server that provides access to the content;
comparing the at least one content delivery characteristic to the at least one threshold value; and
when the comparison indicates that the at least one threshold value is exceeded by the at least one content delivery characteristic, performing further actions, comprising:
modifying at least an initial portion of the requested content to limit its content delivery characteristic to be less than the at least one threshold value;
communicating the modified initial portion to the client computer, wherein the modified portion is substituted for an unmodified initial portion of the requested content; and
after the modified initial portion is communicated to the client computer, further communicating, a remaining portion of unmodified requested content to the client computer.

7. The network computer of claim 6, wherein determining the at least one threshold value, further comprises, determining the at least one threshold value based on at least one characteristic of a request for the requested content.

8. The network computer of claim 6, wherein the at least one determined threshold value, further comprises at least one of a screen resolution, a bitrate, a buffer-size, a compute capacity, or a size of a display for presenting the requested content.

9. The network computer of claim 6, wherein the network computer's processor device executes instructions that enable operations, further comprising, examining a manifest to determine at least one content delivery characteristic of the initial portion of the requested content.

10. The network computer of claim 6, wherein modifying the initial portion of the requested content, further comprises,
determining an alternate content that is substantially equivalent to the requested content except that the at least one content delivery characteristic of the alternate content is less than the at least one threshold value; and
selecting an initial portion of the alternate content, wherein the alternate content's initial portion is substituted for the initial portion of the requested content.

11. A processor readable non-transitory storage media that includes instructions for managing communication of content over a network, wherein a network computer that executes at least a portion of the instructions performs operations, comprising:
when a client computer requests content, determining at least one threshold value for at least one client delivery characteristic to provide the content to the client computer, wherein the at least one threshold value is based on at least one determined network characteristic of the network;
determining at least one content delivery characteristic based on media information provided by a content server that provides access to the content;
comparing the at least one content delivery characteristic to the at least one threshold value; and
when the comparison indicates that the at least one threshold value is exceeded by the at least one content delivery characteristic, performing further actions, comprising:
modifying at least an initial portion of the requested content to limit its content delivery characteristic to be less than the at least one threshold value;
communicating the modified initial portion to the client computer, wherein the modified portion is substituted for an unmodified initial portion of the requested content; and
after the modified initial portion is communicated to the client computer, further communicating, a remaining portion of unmodified requested content to the client computer.

12. The media of claim 11, wherein determining the at least one threshold value, further comprises, determining the at least one threshold value based on at least one characteristic of a request for the requested content.

13. The media of claim 11, wherein the at least one determined threshold value, further comprises at least one of a screen resolution, a bitrate, a buffer-size, a compute capacity, or a size of a display for presenting the requested content.

14. The media of claim 11, further comprising, examining a manifest to determine at least one content delivery characteristic of the initial portion of the requested content.

15. The media of claim 11, wherein modifying the initial portion of the requested content, further comprises,
determining an alternate content that is substantially equivalent to the requested content except that the at least one content delivery characteristic of the alternate content is less than the at least one threshold value; and
selecting an initial portion of the alternate content, wherein the alternate content's initial portion is substituted for the initial portion of the requested content.

16. A system arranged for managing communication of content over a network, comprising:
a network computer, including:
a transceiver for communicating over the network;
a memory for storing at least instructions;
a processor device that executes instructions that enable operations, including:
when a client computer requests content, determining at least one threshold value for at least one client delivery characteristic to provide the content to the client computer, wherein the at least one threshold value is based on at least one determined network characteristic of the network;
determining at least one content delivery characteristic based on media information provided by a content server that provides access to the content;
comparing the at least one content delivery characteristic to the at least one threshold value; and
when the comparison indicates that the at least one threshold value is exceeded by the at least one content delivery characteristic, performing further actions, comprising:
modifying at least an initial portion of the requested content to limit its content delivery characteristic to be less than the at least one threshold value;
communicating the modified initial portion to the client computer, wherein the modified portion is substituted for an unmodified initial portion of the requested content; and
after the modified initial portion is communicated to the client computer, further communicating, a remaining portion of unmodified requested content to the client computer; and
the client computer, comprising:
a transceiver for communicating over the network;
a memory for storing at least instructions;
a processor device that executes instructions that enable operations, including:
requesting the content.

17. The system of claim 16, wherein determining the at least one threshold value, further comprises, determining the at least one threshold value based on at least one characteristic of a request for the requested content.

18. The system of claim 16, wherein the at least one determined threshold value, further comprises at least one of a screen resolution, a bitrate, a buffer-size, a compute capacity, or a size of a display for presenting the requested content.

19. The system of claim 16, wherein the network computer's processor device executes instructions that enable operations, further comprising, examining a manifest to determine at least one content delivery characteristic of the initial portion of the requested content.

20. The system of claim 16, wherein modifying the initial portion of the requested content, further comprises,
determining an alternate content that is substantially equivalent to the requested content except that the at least one content delivery characteristic of the alternate content is less than the at least one threshold value; and
selecting an initial portion of the alternate content, wherein the alternate content's initial portion is substituted for the initial portion of the requested content.
